(19) United States
(12) Patent Application Publication
(10) Pub. No.: US 2011/0019558 A1
(43) Pub. Date: Jan. 27, 2011

(54) DISTRIBUTED LATENCY MEASUREMENT SYSTEM FOR COMMUNICATION SYSTEM ANALYSIS

(75) Inventors: Eric Rowe, Albuquerque, NM (US); Brian Griffin, Albuquerque, NM (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/509,525

(22) Filed: Jul. 27, 2009

(51) Int. Cl. H04L 12/26

(52) U.S. Cl. 370/252

(57) ABSTRACT

Apparatus and methods are provided for generating real-time measured latency data. A message is generated with a time stamp. The time stamp indicates a time the message was sent. The time the message was sent is determined based on a reference-clock source, such as a Global Positioning System (GPS) satellite. A time that the message was received is determined using the reference-clock source. The real-time measured latency data is determined based on the time stamp and the time the message was received. If user data is present in the message, the user data is determined by removing the time stamp from the message. The time stamp and the time the message was received may be generated using a latency-measuring device that is configured to communicate with the reference-clock source. The latency-measuring device may be aboard an unmanned aerial vehicle (UAV) or an unmanned ground vehicle (UGV).

### GOVERNMENT LICENSE RIGHTS

The United States Government has certain rights to this invention under Contract No. W56 HZV-05-C-0724 awarded by the US Army.

### BACKGROUND OF THE INVENTION

1. Field of the Invention

This invention relates to the field of communication system. In particular, this invention relates to real-time latency determinations in communication systems.

2. Background

Unmanned vehicles, such as unmanned aerial vehicles (UAVs) and unmanned ground vehicles (UGVs), are widely used by the military/police, rescue, scientific, and commercial communities. One definition of a UAV is an unmanned device capable of controlled, sustained, and powered flight. Similarly, a UGV may be defined as an unmanned device capable of controlled, sustained, and powered ground travel. As such, the designs of UAVs and UGVs consist of aircraft and ground vehicles, respectively, of various sizes, capabilities, and weights.

A typical UAV or UGV consists of a propulsion device, such as a turbine or engine, a navigation system, and one or more sensors. During operation of UAVs and/or UGVs, the UAVs and UGVs may send data, such as data packets, via a communication network. This data may be time sensitive data, such as video or operational status information.

### SUMMARY

A first embodiment provides a method. A message is received, via a network, at a receiving device. The message includes a time stamp. The time stamp indicates a time for sending the message that is based on a reference-clock source. At the receiving device, a message-reception time for reception of the message is determined. The message-reception time is based on the reference-clock source. Real-time measured latency data is determined based on the time stamp and the message-reception time. The real-time measured latency data is output.

A second embodiment provides a device. The device includes a processing unit, a network-communication device, data storage, and machine-language instructions, stored in the data storage and configured to instruct the processor to perform functions. The functions include: (a) receiving a message via the network-communication interface, where the message includes a time stamp, where the time stamp indicates a time for sending the message, and where the time for sending the message is based on a reference-clock source, (b) determining a message-reception time for reception of the message, where the message-reception time based on the reference-clock source, (c) determining real-time measured latency data based on the time stamp and the message-reception time, and (d) outputting the real-time measured latency data.

A third embodiment provides a method. A message is generated. The message includes a time-stamp. The time stamp indicates a time for sending the message. The time for sending the message is based on a reference-clock source. A determination is made that user data is present. Responsive to determining that the user data is present, the message is updated to include the user data. The message is sent over a network via a network interface.

### BRIEF DESCRIPTION OF THE DRAWINGS

Various examples of embodiments are described herein with reference to the following drawings, wherein like numerals denote like entities, in which:

FIG. 1 shows an example UAV, in accordance with embodiments of the invention;

FIG. 2 shows an example UGV, in accordance with embodiments of the invention;

FIG. 3 shows an example scenario for sending a message from a sending device to a receiving device, in accordance with embodiments of the invention;

FIG. 4 is a block diagram of an example computing device, in accordance with embodiments of the invention;

FIG. 5 is a flowchart depicting an example method for receiving messages, in accordance with embodiments of the invention; and

FIG. 6 is a flowchart depicting an example method for sending messages, in accordance with embodiments of the invention.

### DETAILED DESCRIPTION

The present embodiments are directed to determining latency of communications between a collection of devices that are widely dispersed. The devices may communicate through one or more networks, including wireless networks. Messages sent from a sending device over the network(s) may each incur an amount of transmission delay or “latency” before the messages are received at a receiving device. A common synchronization and reference signal, such as a network timing signal, that may act as a reference clock for determining latency may not be readily available to some or all of the devices in the collection of devices.

Reference-clock signals may be used to determine latencies for communications in the collection of devices. Such reference-clock signals may be broadcast via satellites, such as signals sent from one or more Global Positioning Satellites (GPS). The well-known GPS network of satellites provides access to reference-clock signals virtually anywhere on earth that is within the line of sight of a GPS satellite.

In particular, a GPS satellite may broadcast a signal that includes navigation data (NAV). The navigation data may in turn include one or more accurate timing signals. For example, the IS-GPS-200 Interface Specification indicates a space vehicle (e.g., a GPS satellite) is provided with timing data that has 97 or fewer nanoseconds of apparent uncertainty. This timing data is then used and broadcast as NAV data. See Section 3.3.4, “Naystar GPS Space Segment/Navigation User Interfaces”, IS-GPS-200 Interface Specification, Revision D, Dec. 7, 2004 (“the IS-GPS-200 Interface Specification”). The IS-GPS-200 Interface Specification is entirely incorporated herein by reference for all purposes.

A latency-measurement device may use the reference-clock signal to generate latency data in real-time for messages transmitted via the network. For example, a latency-measurement device used by a sending device may receive user data, determine a time stamp based on a reference-clock signal, generate time-stamped data, and send the time-stamped data in a message over the network to a receiving device. At the receiving device, another latency-measurement device may receive the time-stamped data, retrieve the time stamp, determine the message reception time based on the reference-clock signal, and then determine the latency for the message. The latency can be determined in real time after reception of the message.

The latency-measurement device may remove the time stamp from the time-stamped data, if needed—that is, the original user data may be retrieved by removing the time stamp at the receiving device. Then, the original user data may be output or otherwise processed by the receiving device. In some embodiments, the latency-measurement device on the sending device and the latency-measurement device on the receiving device are identical.

Determining the time stamps based on GPS signals allows use of a widely available, accurate, and stable reference-clock source to provide latency information for messages transmitted between a potentially disparate collection of devices. Chipsets for processing GPS signals, thereby acting as a reference clock based on received GPS signals, are readily available. Use of fixed-length time stamps also aids determination of change in latency due to sending time stamps—once the latency due to sending the time-stamps has been determined, the “true” latency or latency without time-stamp transmission can be readily determined.

Additionally, the real-time measured latency data may be determined as needed. For example, each device in the collection of devices may maintain a “calculate-latency” bit to determine if real-time measured latency data should or should not be calculated. Use of this bit permits the devices in the collection of devices to calculate real-time measured latency data on an as-needed basis; for example, during network testing or for network troubleshooting. The flexibility of this approach saves network and processing resources used to determine latencies when not needed while providing the real-time latency functionality as necessary.

An Example UAV

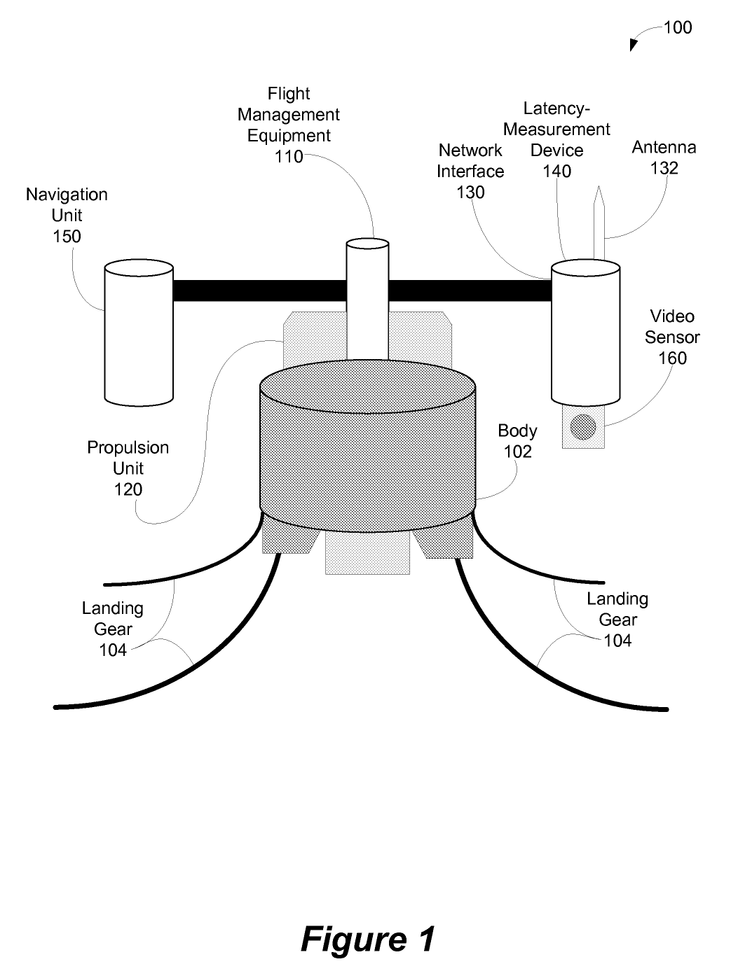

Turning to the figures, FIG. 1 shows an example UAV 100, in accordance with embodiments of the invention. FIG. 1 shows the UAV 100 with body 102, landing gear 104, flight-management equipment 110, propulsion unit 120, network interface 130 with antenna 132, latency-measurement device 140, navigation unit 150, and navigation system 160.

For structural support and other reasons, the UAV 100 may have a body 102 and landing gear 104. The shapes of the body 102 and/or landing gear 104 shown in FIG. 1 are examples only and may vary. For example, the body 102 may have an aerodynamic shape, such as found in a body of a conventional manned aircraft. The landing gear 104 may or may not be retractable into the body 102.

The flight-management equipment 110 may provide guidance to the UAV 100, similar to the control provided by a human pilot in a manned aircraft. The flight-management equipment 110 may include flight controllers and/or servos (electro-mechanical devices) that control various flight-control surfaces of the UAV 100. For example, one or more servos may control a rudder or aileron(s) of the UAV 100. The flight-management equipment 110 may include a fan actuator, instead or as well. In particular, the flight-management equipment 110 may include computer hardware and/or software that implement control, take-off, flight and/or landing sequence(s) of the UAV 100, control any sensors and/or weapons aboard the UAV 100, and/or issue commands to retract or extract the landing gear 104 (if possible).

The propulsion unit 120 may provide power to move the UAV 100. The propulsion units may include one or more engines, fans, pumps, rotors, belts, and/or propellers. One or more engine control units (ECUs) and/or power control units (PCUs) may control the propulsion unit 120. For example, an ECU may control fuel flow in an engine based on data received from various engine sensors, such as air and fuel sensors. The propulsion unit 120 may have one or more fuel tanks, one or more fuel pumps to provide the fuel from the fuel tank(s) to the propulsion unit 120. The propulsion unit 120 may also include one or more fuel-level sensors to monitor the fuel tank(s).

The network interface 130 may permit communication between the UAV 100 and other devices. For example, the network interface 130 may permit communication with other UAVs in use at the same time as the UAV 100. The network interface 130 may permit communication with one or more ground control devices (not shown). A UAV operator may guide and/or observe the UAV 100 using the one or more ground control devices, which may include sending commands, data, and/or receiving notifications from the UAV 100.

The network interface 130 may use one or more wireless communication devices, such as a radio and/or antenna 132, for communication. In an alternative not shown in FIG. 1, the network interface 130 may use one or more wired communication devices, perhaps while the UAV 130 is tethered to the ground.

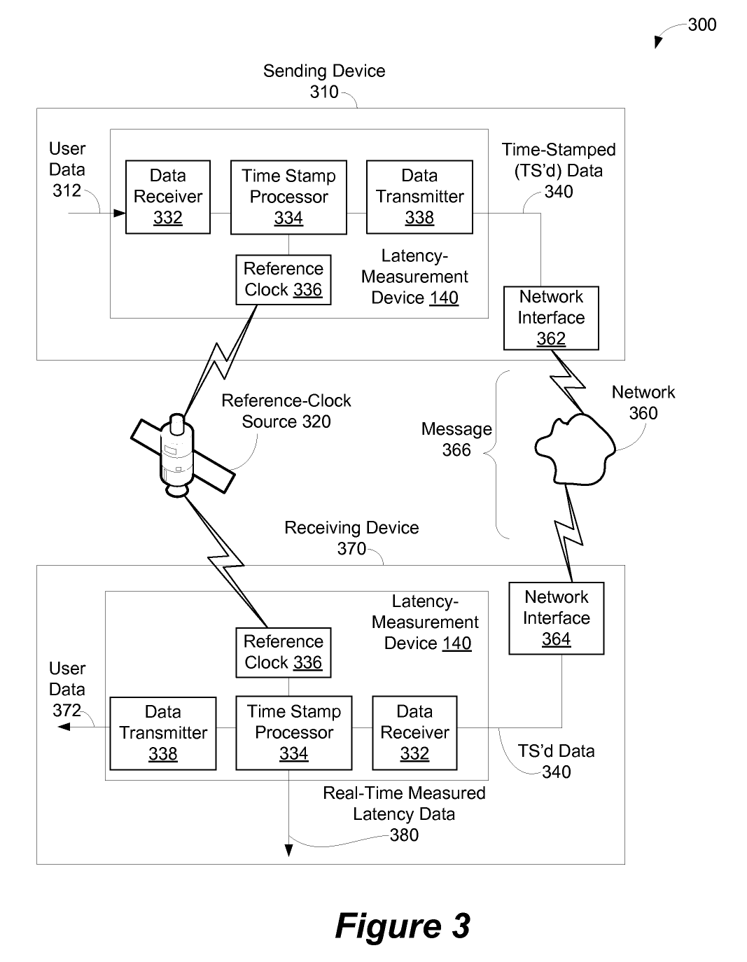

The latency-measurement device 140 may permit time-stamping of communications to and from the UAV 100, such as but not limited to messages sent and/or received via network interface 130. The latency-measurement device 140 may be configured for use in a UAV. For example, the latency-measurement device 140 may be designed to keep weight and power usage at a minimum, as the UAV may be tightly constrained as to how much weight can be carried aboard and/or how much power can be used by components of the UAV. The latency-measurement device 140 is described in more detail below with respect to FIG. 3.

The UAV 100 may have a navigation unit 150. The navigation unit 150 may process navigational data, including location, velocity and/or acceleration data about the UAV 100. The navigational data may include about aircraft nearby the UAV 100. The navigation unit 150 may include other location devices configured to generate some or all of the navigational data, such as, but not limited to, magnetometers, gyroscopes, lasers, Global Positioning System (GPS) receivers, radars, altimeters, and other navigation components. The location devices may include additional sensors to provide additional data about the environment for the UAV 100, such as pressure sensors, thermometers, and/or other environment sensors.

FIG. 1 shows the UAV with a video sensor 160. In other embodiments, the UAV 100 may include more video sensors and/or other electro-magnetic sensors (e.g., microwave detectors, infra-red scanner, ultra-violet sensor). The video sensor 160 may be a camera or other sensor configured to generate one or more “video feeds” or pluralities of frames or images. The video sensor 160 may generate the video feed(s) upon demand (i.e., as a plurality of still shots) and/or at a fixed “frame rate” e.g., 30 frames/second or 60 frames/second. The video feed(s) may be sent over the network interface 130 and/or antenna 132. If the UAV 100 is equipped with multiple video sensors, each video sensor may generate separate video feed(s). The video sensor 160 may be configured to move along one or more degrees of freedom (e.g., along a horizontal line or a vertical line). For example, the video sensor 160 may mounted on two gimbals that permit the video sensor 160 to move along two degrees of freedom. The video sensor 160 may have a “zoom” capability that allows the sensor to increase or decrease magnification of frame(s) in a video feed.

An Example UGV

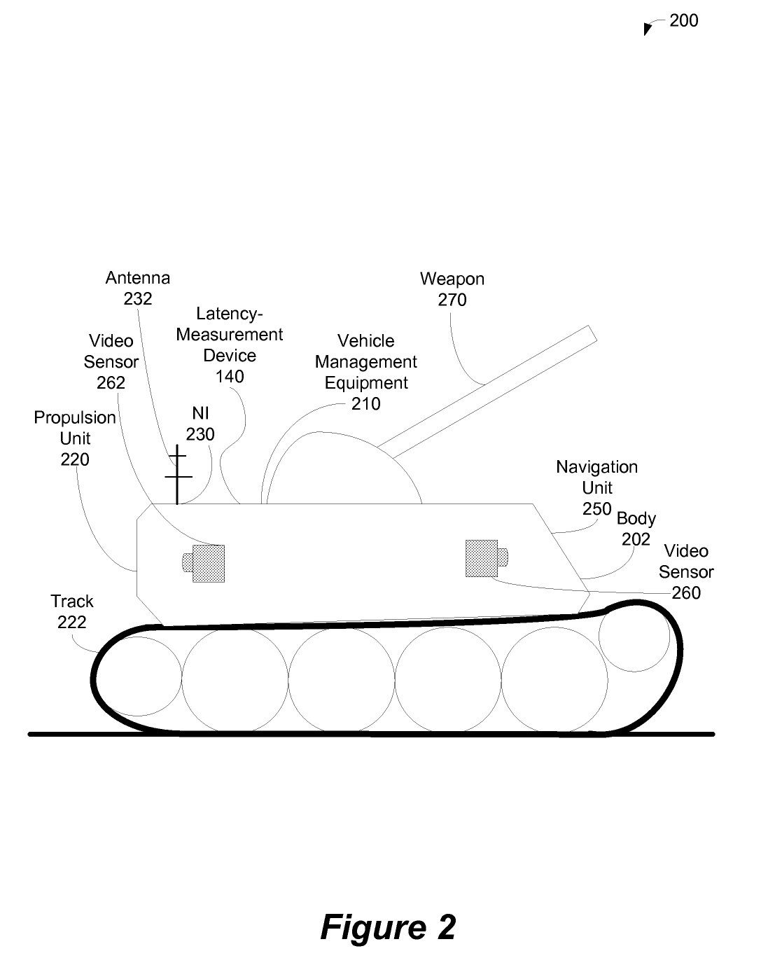

FIG. 2 shows an example UGV 200, in accordance with embodiments of the invention. FIG. 2 shows the UGV 200 with a body 202, vehicle-management equipment 210, a propulsion unit 220 with a track 222, a network interface 230 with an antenna 232, a latency-measurement device 140, a navigation unit 250, and video sensors 260 and 262.

The shape of the body 202 is an example only and may vary. For example, the body 202 may be shaped as a car, cart, truck, van, or other ground vehicle. The vehicle-management equipment 210 may guide the UGV 200, akin to the control provided by a human driver in a manned ground vehicle. The vehicle-management equipment 210 may include servos configured to control vehicle-controls of the UGV 200. For example, one or more servos may control a steering wheel or brakes of the UGV 200. In particular, the vehicle-management equipment 210 may include computer hardware and/or software to start, drive and/or stop the UGV 200, as well as control any sensors and/or weapons aboard the UGV 200.

The propulsion unit 220 may provide power to move the UGV 200. The propulsion units may include one or more engines, turbines, fans, pumps, rotors, and/or belts. One or more engine control units (ECUs) and/or power control units (PCUs) may control the propulsion unit 220. For example, an ECU may control fuel flow in an engine based on data received from various engine sensors, such as air and fuel sensors. The propulsion unit 220 may have one or more fuel tanks, one or more fuel pumps to provide the fuel from the fuel tank(s) to the propulsion unit 220. The propulsion unit 220 may also include one or more fuel-level sensors to monitor the fuel tank(s). FIG. 2 shows the propulsion unit 220 configured to power a track 222 to move the UGV 200. In other embodiments, the propulsion unit 220 may power one or more wheels to move the UGV 200.

The network interface (NI) 230 may permit communication between the UGV 300 and other devices and use the antenna 232, perhaps with a UGV operator using a ground control, such as the network interface described above with respect to the UAV of FIG. 1.

The latency-measurement device 140 may permit time-stamping of communications to and from the UGV 200, such as but not limited to messages sent and/or received via network interface 230. The latency-measurement device 140 may be configured for use in a UGV. For example, the latency-measurement device 140 may be designed to operate after firing of a weapon, such as 270, or in other environments that have considerable variations in temperature, noise, and/or shock waves. The latency-measurement device 140 is described in more detail below with respect to FIG. 3.

The UGV 200 may have a navigation unit 250 that may generate navigational data, including data about other vehicles near to the UGV 200, and use location devices and (additional) sensors such as the navigational system described above with respect to FIG. 2.

FIG. 2 shows UGV 200 with video sensors 260 and 262. In other embodiments, the UGV 200 may have more or fewer video sensors and/or have other electro-magnetic sensors, such as described above with respect to FIG. 2. Each video sensor 260, 262 may generate and/or send video feed(s), move along degree(s) of freedom, and/or have a zoom capability, such as described above with respect to FIG. 2.

FIG. 2 shows the UGV 200 with a weapon 270. The UGV 200 may carry one or more munitions for use with weapon 270 (e.g., artillery shells or small-weapons rounds). In other embodiments, the UGV 200 may be equipped with more, fewer, and/or other weapons, such as those described above with respect to FIG. 2. The weapon 270 also or instead may be a training weapon, such as lasers or loaded with dummy munitions (a.k.a. blanks). The weapon 270 may be and/or include a designator.

Example Feature Tracking Scenarios and Message Flows

FIG. 3 shows a scenario 300 for sending a message 366 from a sending device 310 to a receiving device 370, in accordance with embodiments of the invention. The scenario begins when user data 312 is presented to a latency-measurement device 140 at the sending device 310. The user data 312 may be data—such as but not limited to textual, audio, video, and/or binary data—to be sent to a receiving device and/or a command to send latency-measurement data to the receiving device.

The latency-measurement device 140 at the sending device 310 receives a signal from the reference-clock source 320 at the reference clock 336. The reference clock-source 320 may broadcast a signal that may be used as a reference-clock signal. In some embodiments, the reference clock-source 320 is one or more GPS satellites and the reference-clock signal may be a GPS signal. The GPS signal may contain navigation data with one or more timing signals, as described in the IS-GPS-200 Interface Specification. The navigation data may be processed to generate a reference-clock time. That is, the navigation data may be parsed or otherwise decoded to determine an initial time as indicated by the one or more timing signals. Further, the navigation data may include correction values, such as differential correction parameters, for application to the initial time for determining the reference-clock time. Also, the determined reference-clock time may account for transmission delay from a GPS satellite to sending device 310 and/or receiving device 370.

Based on the reference clock 336 at the sending device 310, the time stamp processor 334 at the sending device 310 may generate a time stamp. The time stamp may be generated at the sending device 310 based on: receiving user data 312 at the data receiver 332, reception of an internal or external signal instructing the sending device 310 to generate the time stamp, reception of a signal from the reference-clock source 360, and/or other considerations (e.g., periodically). In particular, the time stamp processor 334 and/or the reference clock 336 may determine the time stamp by processing GPS signals to determine the reference-clock time, as discussed in the paragraph above. The time stamp may indicate a time the message 366 is to be sent from the sending device 310. In some embodiments, the time stamp may have a fixed length (e.g., 64 bits) to permit ready inclusion or exclusion in a header or other portion of the message 366.

The time stamp may additionally indicate the reference-clock source 360 (e.g., an identifier of a satellite or other device used as the reference-clock source 360) used as a reference to generate the time stamp. If the reference-clock source 360 is identified, the receiving device 370 may use the identified reference-clock source as well. For example, if GPS Satellite #4 is used as the reference-clock source, then the time stamp may additionally indicate which that GPS Satellite #4 was used as the reference-clock source. Then, the receiving device 370 may decide to use GPS Satellite #4 as a reference-clock source to minimize discrepancies between reference clock sources.

In some scenarios, the sending device 310 and the receiving device 370 may use different reference-clock sources, perhaps due to locations of the sending device 310 and the receiving device 370, local environmental conditions at each of the locations of the sending device 310 and the receiving device 370, and/or different equipment (e.g., hardware and/or software) at sending device 310 and receiving device 370. Other reasons for using different reference-clock sources are possible as well.

Even if no reference-clock source is specifically indicated in a time stamp or other data, the sending device 310 and the receiving device 370 may use the same reference-clock source. For example, the sending device 310 and the receiving device 370 may be pre-programmed (i.e., “hard-coded”) to use the same reference-clock source. As another example, the sending device 310 and the receiving device 370 may each execute a reference-clock-location algorithm that select the reference-clock source from among a plurality of reference-clock sources. The algorithm may select the reference-clock source based one or more conditions, such as but not limited to communication conditions (e.g., select the reference-clock source with a strongest signal strength and/or best signal-to-noise ratio), reliability of the reference-clock sources, availability of the reference-clock source, and/or application requirements (e.g., choose a different reference-clock source for military applications than used for commercial applications).

The sending device 310 and the receiving device 370 may negotiate a reference-clock source as the same reference-clock source. For example, the sending device 310 may send one or more choices of reference-clock sources to the receiving device 370. The receiving device 370 may then select one of the choices of reference-clock sources and send a notification of the chosen reference-clock source to the sending device 310; e.g., if the sending device 310 sends reference-clock-source choices of GPS Satellites #1, #2, and #3, the receiving device may select GPS Satellite #2. The sending device 310 and the receiving device may both use the chosen reference-clock source. Similarly, the roles of the sending device 310 and the receiving device 370 in the previous example may be reversed (e.g., the receiving device 310 sends choices to the sending device 370, which then indicates the chosen reference-clock source).

In response to receiving one or more choices of reference-clock sources, another response may be to provide a notification of a chosen reference-clock source that is not one of the received one or more choices of reference-clock sources (e.g., if the sending device 310 sends reference-clock-source choices of GPS Satellites #1, #2, and #3, the receiving device may select GPS Satellite #4). In this scenario, the sending device 310 and receiving device 370 may negotiate to use different reference-clock sources. Other techniques for negotiating reference-clock sources are possible as well.

Once the time stamp is generated at the sending device 310, the time-stamp processor 334 and/or the data transmitter 336 at the sending device 310 may receive the user data 312 and the time stamp and generate time-stamped (TS'd) data 340 for use by the network interface 362. For example, the time-stamped data 340 may be generated by concatenating the time stamp and the user data 312. The network interface 362 may send the message 366 including the time-stamped data 340 via the network 360. The message 366 may include the time stamped data 340, including the time stamp, a header, and/or a footer in accordance with one or more communication protocols used by the network 366. The message 366 may be generated at the sending device 310 by the time stamp processor 334, data transmitter 336 and/or network interface 362.

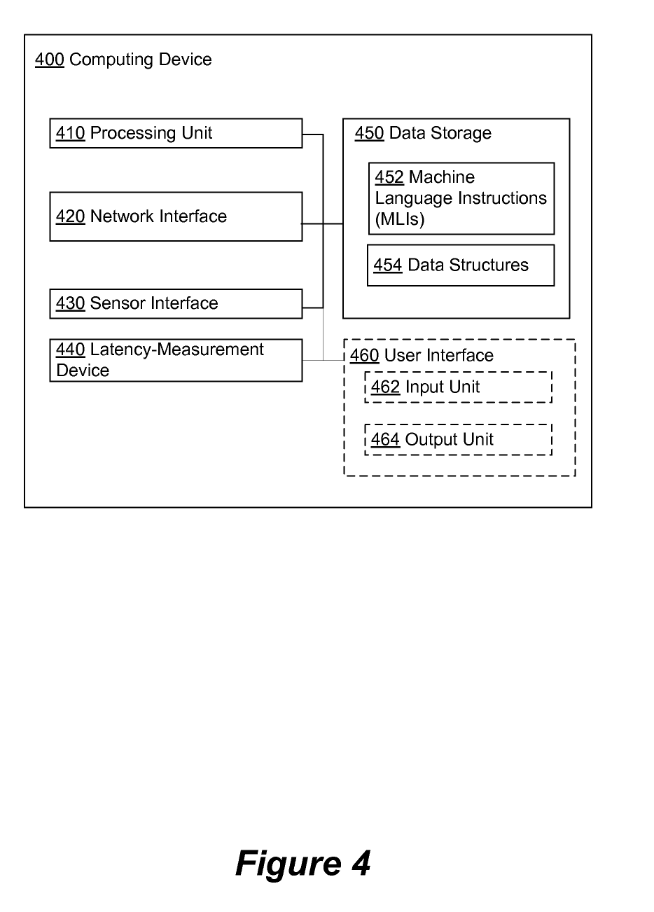

In some embodiments, the data receiver 332 and the data transmitter 336 may be memory buffers and/or devices configured to store data received or transmitted, respectively, by the latency-measurement device 140. In these embodiments, the time stamp processor 334 may be a processing unit, perhaps equipped with other portions of the computing device such as data storage and/or a user interface, described below with respect to FIG. 4. In these embodiments, the time stamp processor 334 may receive a time stamp and perhaps the user data from the reference clock 336 and the data receiver 332, respectively, and generate the time-stamped data 340.

The time-stamped data 340 generated at the sending device 310 may be formatted as the message 366. In some embodiments, the time stamp processor 334 may format the time-stamped data 340 as the message 366 and provide the time-stamped data 340 to the data transmitter 336 (e.g., place the time-stamped data 340 in a buffer). Then, the network interface 362 may retrieve the time-stamped data 340 from the data transmitter 336 and send the time-stamped data formatted as the message 366 via the network 360. In other embodiments, the network interface 362 may add and/or update information to format the time-stamped data 340 as the message 366. This information may be required by one or more communications protocols (e.g., addressing information, sequence numbering, size information about the message, etc.) used by the network 360.

Upon reception of the message at the network interface 364 of the receiving device, the time-stamped data 340 may be extracted from the message 366 at the network interface 364 (if necessary). At the sending device 370, the time-stamped data 340 may be received at the data receiver 332 and passed on to the time stamp processor 334. The time stamp processor 340 at the receiving device 370 may generate the real-time measured latency data 380 by: extracting the time stamp from the time stamped data 340, receiving an indication of a time that the message 366 was received at the network interface 364 from the reference clock 366, subtracting the time that the message 366 was received at the network interface 366 from the time the message 366 was sent (as stored in the time stamp) to determine the latency of the message 366. Many other techniques to generate the real-time measured latency data 380 are possible as well.

The real-time measured latency data 380 may include additional data beyond the latency of the message 366. For example, the real-time measured latency data 380 may include time(s) the message 366 was received and/or sent, addressing and/or identifying information about the sending device 310 and/or the receiving device 370, and/or information about the amount of data or size sent in the message 360. The real-time measured latency data 380 may include statistical data about latency at the receiving device 370, such as mean, median, and/or mode latency information determined by observing a pre-determined and/or selectable amount of time or number of packets (e.g., the median latency over 100 packets or the mean latency over 10 seconds). The real-time measured latency data 380 may include information from messages received from one or more sending devices and may be broken down by sending device (e.g., the real-time measured latency data taken over a 10 second interval may indicate: a mean latency of 10 ms over 12 packets received from device #3 and a mean latency of 13 ms for 3 packets received from device #323, etc.). Many other types and amounts of additional data beyond the latency of the message 366 may be included in the real-time measured latency data 380 as well.

The real-time measured latency data 380 may be used internally by the receiving device 370. For example, the receiving device 370 may use the real-time measured latency data 380 to estimate the latency to send messages to the sending device 310, to make routing decisions for sending future packets, and/or to aid determinations that subsequent messages are lost and need to be retransmitted. For example, suppose the latency from the receiving device 370 to the sending device 310 is determined to be 10 ms, and an expected message is not received within an interval of twice (or another multiplier) of the latency—e.g., 20 ms, the receiving device 370 may determine the expected message was lost during transmission and request retransmission of the expected message.

The real-time measured latency data 380 may be output by the receiving device 370. The real-time measured latency data 380 may be output textually, audibly, graphically, and/or in binary format. Additionally or instead, the real-time measured latency data 380 may be stored in binary, textual, audio, and/or graphic form. Other output methods are possible as well.

As shown in FIG. 3, the latency-measuring devices 140 in the sending device 310 and the receiving device 370 are identical. Thus, the real-time measured latency data 380 may be determined at the sending device 310 for messages sent from the receiving device 370 (or perhaps sent from other devices as well) using the techniques described herein. In alternate embodiments, the latency-measuring devices 140 in the sending device 310 and the receiving device 370 may not be identical while performing the techniques described herein; for example, the latency-measuring devices 140 in the sending device 310 and the receiving device 370 may each have different versions of hardware/and or software and/or may use different types of reference-clock sources.

An Example Computing Device

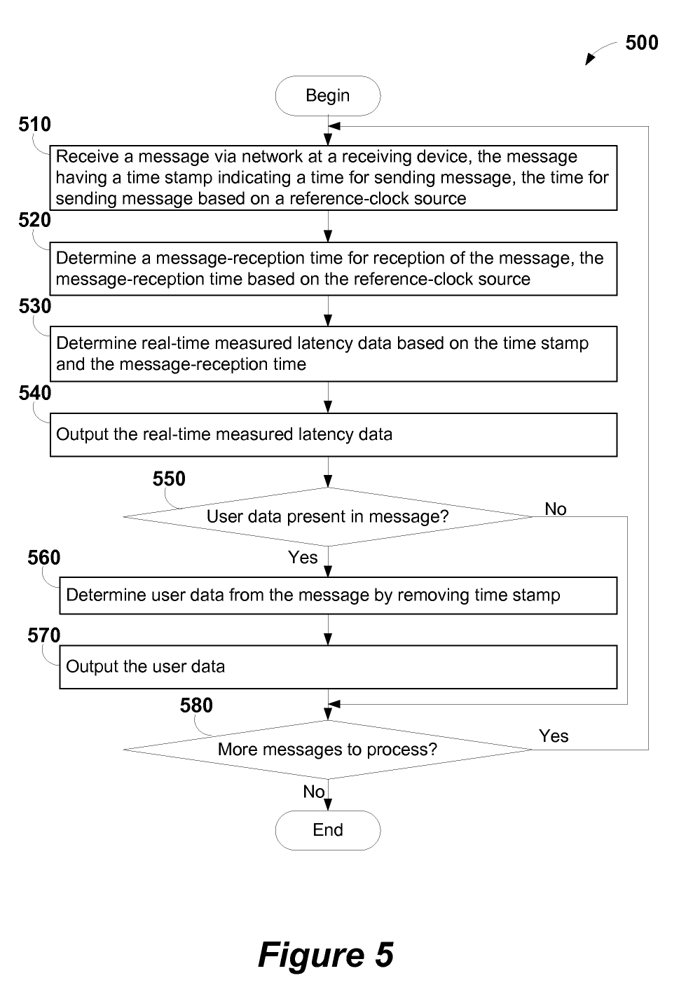

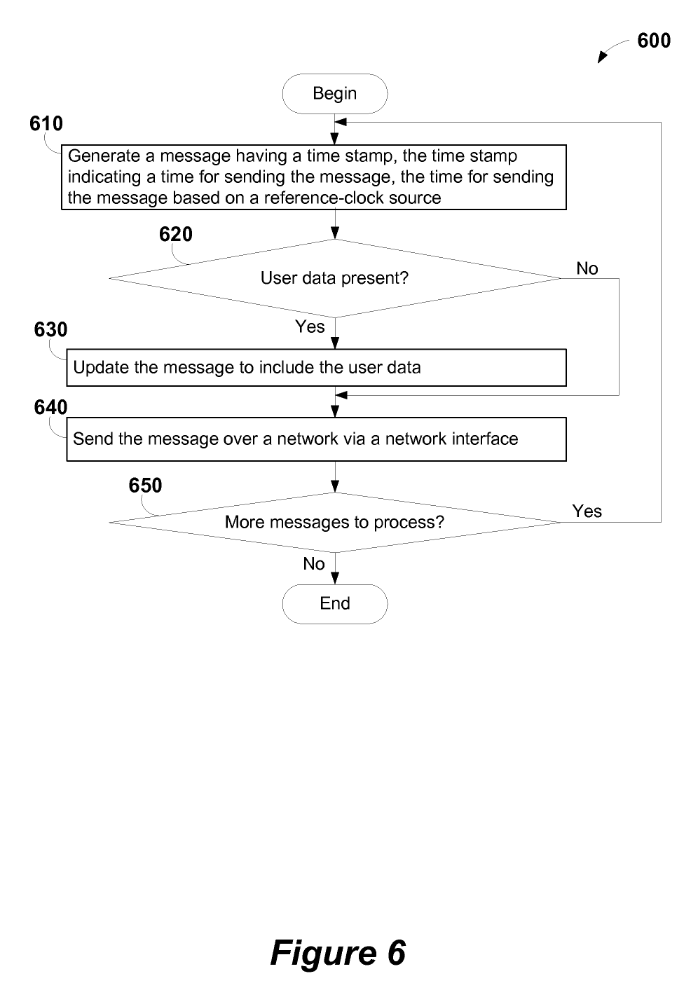

FIG. 4 is a block diagram of an example computing device 400 comprising a processing unit 410, a network interface 420, and a sensor interface 430, a latency-measurement device 440, data storage 450, and an optional user interface 460, in accordance with embodiments of the invention. The computing device 400 may be a light-weight embedded processor, a desktop computer, laptop or notebook computer, personal data assistant (PDA), mobile phone, or any similar device that is equipped with a processing unit capable of executing machine-language instructions that implement at least part of the herein-described methods 500 and 600, described in more detail below with respect to FIGS. 5 and 6, respectively, and/or herein-described functionality of a UAV, UGV, sending device, receiving device, latency-measurement device, a ground control, a tracking system, tracking unit, flight-management equipment, vehicle-management equipment, video sensor, weapon, a navigation system, and/or a data link.

The processing unit 410 may include one or more central processing units, computer processors, mobile processors, digital signal processors (DSPs), microprocessors, computer chips, and similar processing units now known and later developed and may execute machine-language instructions and process data.

The network interface 420 may be configured to send and receive data over a wired-communication interface and/or a wireless-communication interface. The wired-communication interface, if present, may comprise a wire, cable, fiber-optic link or similar physical connection, such as a USB, SCSI, Fire-Wire, and/or RS-232 connection, to a data network, such as a wide area network (WAN), a local area network (LAN), one or more public data networks, such as the Internet, one or more private data networks, or any combination of such networks. A UAV, such as UAV 100, may be tethered to the ground before utilizing the wired-communication interface of the network interface 420.

The wireless-communication interface, if present, may utilize an air interface, such as a Bluetooth™, ZigBee, Wireless WAN (WWAN), Wi-Fi, and/or WiMAX interface to a data network, such as a WWAN, a Wireless LAN, one or more public data networks (e.g., the Internet), one or more private data networks, or any combination of public and private data networks. In some embodiments, the network interface 420 is configured to send and/or receive data over multiple communication frequencies, as well as being able to select a communication frequency out of the multiple communication frequency for utilization. The wireless-communication interface may also, or instead, include hardware and/or software to receive communications over a data-link via an antenna; for example antenna 132 or 232.

The sensor interface 430 may permit communication with one or more sensors, including but not limited to the video sensors and sensors needed by or described as a propulsion unit, navigation unit, location devices, flight-management equipment, and/or vehicle-management equipment as described above with respect to FIGS. 1 and 2.

The latency-measurement device 440 may permit time-stamping of communications to and from the computing device, such as but not limited to messages sent and/or received via network interface 420. For example, the latency-measurement device 440 may comprise the components and functionality of the latency-measurement device 140 described in more detail above with respect to FIGS. 1-3.

The data storage 450 may comprise one or more storage devices. The data storage 450 may include read-only memory (ROM), random access memory (RAM), removable-disk-drive memory, hard-disk memory, magnetic-tape memory, bubble memory, cache memory, flash memory, and similar storage devices now known and later developed. As such, data storage 450 may include and/or encode one or more computer-readable media with instructions that are configured to be executed by the processing unit, such as but not limited to, machine-language instructions 452. The data storage 450 comprises at least enough storage capacity to contain machine-language instructions 452 and data structures 454.

The machine-language instructions 452 and data structures 454 contained in the data storage 450 include instructions executable by the processing unit 410 and any storage required, respectively, to perform some or all of the herein-described functions of UAV, UGV, sending device, receiving device, latency-measurement device, a ground control, a tracking system, tracking unit, flight-management equipment, vehicle-management equipment, video sensor, weapon, a navigation system, and/or a data link, and/or to perform some or all of the procedures described in methods 500 and/or 600.

The user interface 460 is optionally part of the computing device 400, as indicated in FIG. 4 by the use of dashed lines. The user interface 460 may comprise an input unit 462 and/or an output unit 464. The input unit 462 may receive user input from a user of the computing device 400. The input unit 462 may comprise a steering device, keyboard, a keypad, a touch screen, a computer mouse, a track ball, a joystick, and/or other similar devices, now known or later developed, capable of receiving user input from a user of the computing device 400.

The output unit 464 may provide output to a user of the computing device 400. The output unit 434 may comprise a visible output device for generating visual output(s), such as one or more cathode ray tubes (CRT), liquid crystal displays (LCD), light emitting diodes (LEDs), printers, lights, and/or other similar devices, now known or later developed, capable of displaying graphical, textual, and/or numerical information to a user of computing device 400. The output unit 464 may alternately or additionally comprise one or more aural output devices for generating audible output(s), such as a speaker, speaker jack, audio output port, audio output device, earphones, and/or other similar devices, now known or later developed, capable of conveying sound and/or audible information to a user of computing device 400.

Example Method for Receiving Messages

FIG. 5 is a flowchart 500 depicting an example method for receiving messages, in accordance with embodiments of the invention. It should be understood that each block in this flowchart and within other flowcharts presented herein may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

Method 500 begins at block 510. At block 510, a message may be received via a network at a receiving device. The message includes a time stamp that indicates a time for sending the message. The time for sending the message is based on a reference-clock source. The receiving device, network, and reference-clock device may be as described above with respect to FIG. 3. In particular, the reference-clock device may be one or more GPS satellites.

At block 520 a message-reception time for reception of the message may be determined at the receiving device. The message-reception time may be based on the reference-clock source. The receiving device may have a latency-measurement device, such as described above with respect to FIG. 3. The latency-measurement device may determine the message-reception time as also described above with respect to FIG. 3. The latency-measurement device may be used in a wide variety of devices, such as but not limited to UAVs, UGVs, other vehicles, and/or in communication devices, such as the computing unit described above with respect to FIG. 4.

At block 530, real-time measured latency data may be determined. The real-time measured latency data may be based on the time stamp and the message-reception time. The real-time measured latency data may be determined as described above with respect to FIG. 3.

At block 540, the real-time measured latency data may be output. The real-time measured latency data may be output using one or more output techniques. Example output techniques include, but are not limited to: writing the real-time measured latency data into a memory buffer, displaying the real-time measured latency data on a display device, printing the real-time measured latency data, and/or transmitting the user data perhaps via a network using a network interface. Many other output techniques are possible as well.

At block 550, a determination is made as to whether user data is present in the message. This determination may be made by examining a header or other data about message that provides a message length, by examining the header or other data for a sub-header or reference to user data, by searching the message for user data, or a combination thereof. Many other techniques for determining the presence of user data are possible as well. If user data is present in the message, method 500 may proceed to block 570. If user data is not present in the message, method 500 may end.

At block 560, the user data is determined from the message by removing the time stamp. Other processing may be performed as well, such as by decompressing or compressing user data, encrypting or decrypting user data, removing additional information.

In some embodiments, the user data may be considered to include the time stamp as well as part of the procedures of block 550. In such embodiments, the procedures of block 560 that remove the time stamp may be skipped.

At block 570, the user data is output. The user data may be output using any or all of the output techniques described above with respect to block 540.

At block 580, a determination is made whether there are more messages to process. The determination may be made based on determining a number of messages a message queue or similar data structure.

Also or instead, the determination may also be made based on a “calculate-latency” bit. The calculate-latency bit may be set based on: hard-coded data, one or more calculations performed at a device (e.g., the calculate-latency bit may set based on observation of network conditions, such as dropped packet counts, signal-to-noise ratios, and/or other network parameters), and/or user input. Also or instead, the calculate-latency bit may be set based on input received in one or more messages (e.g., a calculate-latency bit setting may be sent as part of a specific message and/or “piggy-backed” or sent with another message).

Each device may determine if real-time measured latency data should be collected. For example, a device #1 may determine that real-time measured latency data should be collected from a device #2 by: (a) observing incoming messages from device #2, (b) determining real-time measured latency data should be collected from device #2 (and perhaps set the calculate-latency bit to “1”) if the incoming message have time-stamps, and (c) determining real-time measured latency data should be not collected from device #2 (and perhaps set the calculate-latency bit to “0”) if the incoming message do not have time-stamps. Similarly, device #1 can implicitly signal to device #2 that real-time measured latency data should, or should not, be collected by sending or not sending, respectively, time stamps to device #2. Other techniques for setting the calculate-latency bit are possible as well.

The calculate-latency bit may be set to “1” or active at a device if real-time measured latency data is to be calculated (i.e., a receiving device should scan received messages for time-stamps in order to determine real-time measured latency data). The calculate-latency bit may be set to “0” or inactive at the device if real-time measured latency data is to be calculated. If the calculate-latency bit is “0” at the device, then time-stamps may not be part of received messages and/or may be ignored or otherwise not expected in received messages at the device. Other techniques for determining that there are more messages to process may be used instead and/or as well. The calculate-latency bit may be “global” or used for all communications for the device or “local” or set for one or more specific devices where latency is to be measured. In the case of local calculate-latency bits, a data structure, such as an array, bit map, or linked list, may include one calculate-latency bit for each device communicating with a specific device. For example, if device #1 receives messages from 200 other devices over a period of time, the data structure may permit tracking of calculate-latency bits for each of the 200 other devices device #1 communicates with. The data structure may also include an identifier for each “far-end” or communicating device as well; e.g., at device #1, the calculate-latency bit for device #2 is “1”, the calculate-latency bit for device #3 is “0”, etc. Many other data structures for calculate-latency bits are possible as well.

After performing the procedures of block 580 and determining there are more messages to process, method 500 may proceed to block 510.

After performing the procedures of block 580 and determining there are no more messages to process, method 500 may end.

Example Method for Sending Messages

FIG. 6 is a flowchart 600 depicting an example method for receiving messages, in accordance with embodiments of the invention.

At block 610, a message is generated. The message includes a time-stamp that indicates a time for sending the message. The time for sending the message is based on a reference-clock source. The reference-clock source may be a GPS reference-clock source, such as one or more GPS satellites.

The time-stamp may be generated at a latency-determination device, such as latency-determination device 140 described above with respect to FIGS. 1, 2, and 3. The latency-determination device may receive a signal from the reference-clock source at a reference clock. The signal may include navigation data from one or more GPS satellites. Many other possible signals are possible as well. The reference clock may generate the time-stamp, which is indicates the time for sending the message, based on the received signal from the reference clock. The latency-measurement device may then generate the message based on the time stamp. The latency-measurement device may be utilized on a UAV, UGV, a ground control for a UAV and/or UGV, or on other communications devices.

At block 620, a determination is made that user data is present. The user data may be data to be sent to a receiving device and/or a command to send latency-measurement data to the receiving device. If user data is present, method 600 proceeds to block 630. If user data is not present, method 600 proceeds to block 640.

At block 630, the message is updated to include the user data. The message may be updated as described above with respect to FIG. 3 for the generation of time-stamped data and/or messages.

At block 640, the message is sent over a network via a network interface. The message may be sent as described above with respect to FIG. 3.

At block 650, a determination is made whether there are more messages to process. The determination may be made based on determining a number of messages a message queue or similar data structure. Also or instead, the determination may also be made based on a calculate-latency bit. The calculate-latency bit may be the calculate-latency bit described above with respect to block 580 of FIG. 5.

In the context of method 600, a setting of “1” for the calculate-latency bit may indicate that messages are to be generated with time stamps and a setting of “0” for the calculate-latency bit may indicate that messages are to be generated without time stamps. Other techniques for determining that there are more messages to process may be used instead and/or as well.

After performing the procedures of block 650 and determining there are more messages to process, method 600 may proceed to block 610.

After performing the procedures of block 650 and determining there are no more messages to process, method 600 may end.

### CONCLUSION

Exemplary embodiments of the present invention have been described above. Those skilled in the art will understand, however, that changes and modifications may be made to the embodiments described without departing from the true scope and spirit of the present invention, which is defined by the claims. It should be understood, however, that this and other arrangements described in detail herein are provided for purposes of example only and that the invention encompasses all modifications and enhancements within the scope and spirit of the following claims. As such, those skilled in the art will appreciate that other arrangements and other elements (e.g. machines, interfaces, functions, orders, and groupings of functions, etc.) can be used instead, and some elements may be omitted altogether.

Further, many of the elements described herein are functional entities that may be implemented as discrete or distributed components or in conjunction with other components, in any suitable combination and location, and as any suitable combination of hardware, firmware, and/or software.

We claim:

1. A method, comprising:
receiving a message via a network at a receiving device, the message comprising a time stamp, wherein the time stamp indicates a time the message was sent based on a first signal from a reference-clock source;
wirelessly receiving a second signal from the reference-clock source;
at the receiving device, determining a message-reception time for reception of the message based a time indicated in the second signal;
determining real-time measured latency data based on the time stamp and the message-reception time; and
outputting the real-time measured latency data.

2. The method of claim 1, wherein receiving the second signal comprises receiving the second signal at a latency-measurement device, wherein the latency-measurement device comprises a data receiver, a data transmitter, a reference clock, and a time-stamp processor.

3. The method of claim 2, wherein the latency-measurement device is configured to be utilized aboard an unmanned aerial vehicle (UAV).

4. The method of claim 2, wherein determining the message-reception time comprises determining the message-reception time at the reference clock.

5. The method of claim 2, wherein determining real-time measured latency data comprises determining real-time measured latency data at the latency-measurement device.

6. The method of claim 1, wherein the reference-clock source is a Global Positioning System (GPS) reference-clock source.

7. The method of claim 6, wherein the reference-clock source is one GPS satellite.

8. The method of claim 7, wherein the message further comprises transmitted data, and wherein the method further comprises:
determining the transmitted data from the message, based on removing the time stamp from the message; and
after removing the time stamp, outputting the transmitted data.

9. A device, comprising:
a processing unit;
a network-communication device;
data storage; and
machine-language instructions, stored in the data storage and configured to instruct the processor to perform functions, the functions comprising:
receiving a message via the network-communication interface, the message comprising a time stamp, wherein the time stamp indicates a time the message was sent based on a first signal from a reference-clock source,
wirelessly receiving a second signal from the reference-clock source,
determining a message-reception time for reception of the message based a time indicated in the second signal,
determining real-time measured latency data based on the time stamp and the message-reception time, and
outputting the real-time measured latency data.

10. The device of claim 9, further comprising a latency-measurement device configured to receive at least the second signal wirelessly from the reference-clock source.

11. The device of claim 10, wherein the device is configured to be utilized aboard an unmanned aerial vehicle (UAV).

12. The device of claim 10, wherein the device is configured to be utilized aboard an unmanned ground vehicle (UGV).

13. The device of claim 10, wherein the reference-clock source is a Global Positioning System (GPS) reference-clock source.

14. The device of claim 13, wherein the functions further comprise: negotiating a GPS satellite to be used as the reference-clock source.

15. The device of claim 9, wherein the message further comprises transmitted data.

16. The device of claim 15, wherein the functions further comprise:
determining the transmitted data from the message, based on removing the time stamp from the message; and
after removing the time stamp, transmitting the transmitted data.

17. A method, comprising:
generating a message comprising a time-stamp, wherein the time stamp indicates a time for sending the message, and wherein the time for sending the message is based on a wireless signal received from a reference-clock source;
determining that user data is present;
responsive to determining that the user data is present, updating the message to include the user data; and
sending the message over a network via a network interface.

18. The method of claim 17, wherein the reference-clock source is a Global Positioning System (GPS) reference-clock source.

19. The method of claim 17, wherein generating the message comprises generating the message at a latency-measurement device, and wherein the latency-measurement device is configured to:
receive the wireless signal at a reference clock;
generate the time-stamp based on the wireless signal; and
generate the message based on the time-stamp.

20. The method of claim 19, wherein the latency-measurement device is configured to be utilized aboard an unmanned aerial vehicle (UAV).
